(19) United States
(12) Patent Application Publication
(10) Pub. No.: US 2008/0288269 A1
(43) Pub. Date: Nov. 20, 2008

(54) Enterprise-wide data standardization structure and method

(75) Inventor: Volker Herwig, Orlando, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/804,403

(22) Filed: May 18, 2007

(51) Int. Cl. G06Q 10/00

(52) U.S. Cl. 705/1

(57) ABSTRACT

A method and structure for data standardization as a basis for a service-oriented architecture in an enterprise. A logical business model (30) defines processes and organization of an enterprise. An implementation model (40) defines an information technology to support the business model (30). Standard core language elements (60) communicate and transition reliably between the business and implementation models, and are understandable in the same way by all responsible parties in a business. Business object types (60) and technical term models (66) define core elements with semantics, synonyms, and interrelationships of this standard language. The models (30, 40) as encoded in a database coordinate the parties and departments in implementing a product life cycle in the enterprise.

### FIELD OF THE INVENTION

This invention relates to management of enterprise data for product life cycle management, supply chain management, and customer relationship management for information technology support of multi-departmental activities. In particular it relates to enterprise-wide standardization of semantic relationships between a business model and a supporting information technology model.

### BACKGROUND OF THE INVENTION

Service-oriented business architectures have gained attention in publications and conferences for years, promising cost saving efficiencies and easier adaptability to changes in businesses, markets, and support technologies. However, uses of such architectures in enterprises have been surprisingly low. A reason for this situation is a lack of standardization in communication languages for information technologies (IT) in enterprises. Standardization is needed because messages between services and between departments must be understood by all participants. Problems arise in software development for IT support of business processes. Different people using the same process may have widely different understandings of the information elements they use. People responsible for IT solutions try to accommodate all of these diverse understandings into one product, often failing because of a lack of common understanding and transparency, resulting in redundancy and inconsistencies in the support data.

It has been estimated that approximately thirty five percent of the total cost of IT application design, development, and maintenance is due to integration costs. In most cases these are costs for standardizing the information and data used as the basis for the technical integration, rather than for the technical integration itself.

### BRIEF DESCRIPTION OF THE DRAWINGS

The invention is explained in the following description in view of the drawings that show:

FIG. 1 is a schematic view of phases of an information technology product life cycle (Plc) in support of a business model.

FIG. 2 shows a business view and an implementation view of a Plc.

FIG. 3 shows a business view using process models.

FIG. 4 shows an event-driven process chain (EPC) and a function allocation diagram (FAD).

FIG. 5 shows a definition of a given business object type

FIG. 6 shows a technical term model that defines semantic relationships among business object types

FIG. 7 shows a problem domain modeling stage between a business view and an implementation view.

### DETAILED DESCRIPTION OF THE INVENTION

An aspect of the invention is to use business specifications and business process documentation as a starting point to develop a common business language model before application development starts. In this paradigm, every business and IT change depends upon business processes, and data standardization is tied to business processes as well. This provides a holistic approach to IT support and data interchange, promoting a common understanding of each project among departments and personnel of a business, and avoiding overlap and duplication of functions, software, and process steps.

Disparities in semantics in a business and/or IT model at different levels is a problem because people must understand the bigger picture of which they are a part, in order to implement the smaller picture for which they are responsible. Thus, a holistic view of a company's information architecture is needed. In the approach used herein, this view starts with the information needs of business people based on business processes, and ends with IT applications supporting these information needs. The invention focuses on reducing integration costs, and creates a basis for fully implementing service-oriented architectures. The modeling methodology herein focuses on semantic information in standardized data structures.

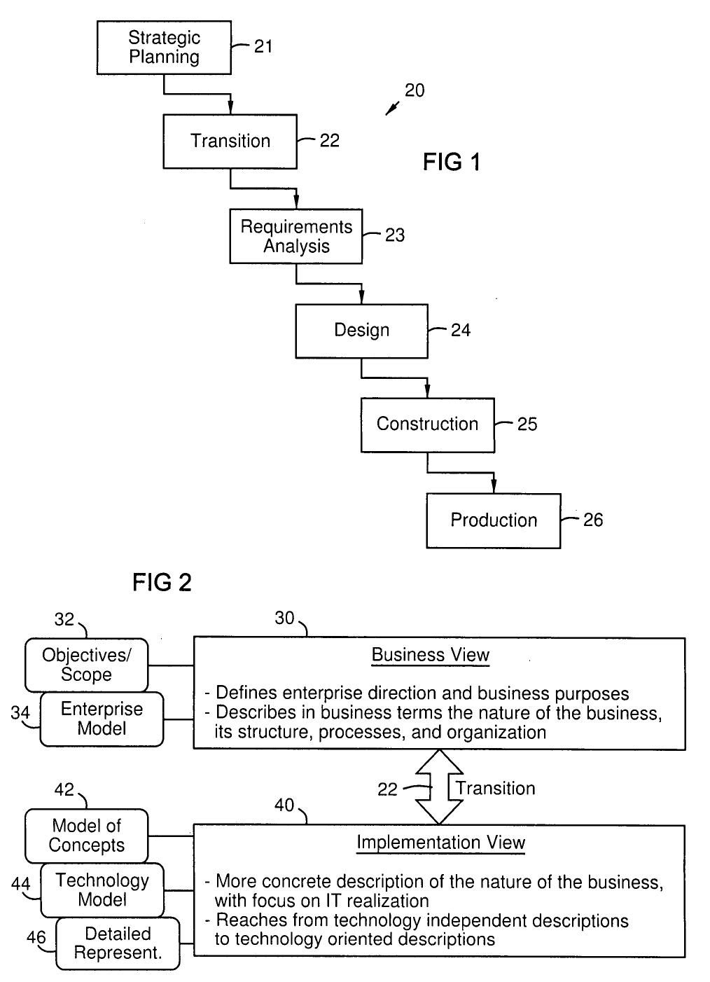

FIG. 1 illustrates phases in a development process 20 for IT products. Strategic Planning 21 involves developing a vision of the product environment, establishing priorities, and defining basic conditions. Each product is assigned a place in the overall product spectrum, and is subordinated to a top-level corporate goal. Boundaries to other products are defined. During a Requirements Analysis 23, project requirements are defined and documented, especially from the point of view of business and support.

As shown in FIG. 2, the starting point for Strategic Planning 21 is a business view or model 30, from which a technology-driven implementation view 40 is developed in the Requirements Analysis 23. Technologies and architectures for implementing the requirements are defined during a Design Phase 24. These architectures are then implemented in technology during a Construction Phase 25. A Production Phase 26 focuses on product maintenance and assurance of uniformity to formulated requirements.

A challenge in this process is the Transition 22 between the view of the business 30 and the view of the IT or the implementation view 40. The business view 30 broadly defines objectives and scope 32, direction, purpose, entities, processes, and flow in a relatively non-technical enterprise model 34, but lacks specifications for the information needs of those entities and processes. Furthermore, understanding of the business processes can differ greatly among different people responsible for those processes. This is especially true in larger enterprises, and may reflect historic changes in business models that were not documented and standardized or not enforced. The implementation view 40 is a specification for the IT implementation and support of the business view. In the implementation view 40, logical models 42, physical data models 44, and detailed representations 46, such as data tables, data displays, or input templates, are created.

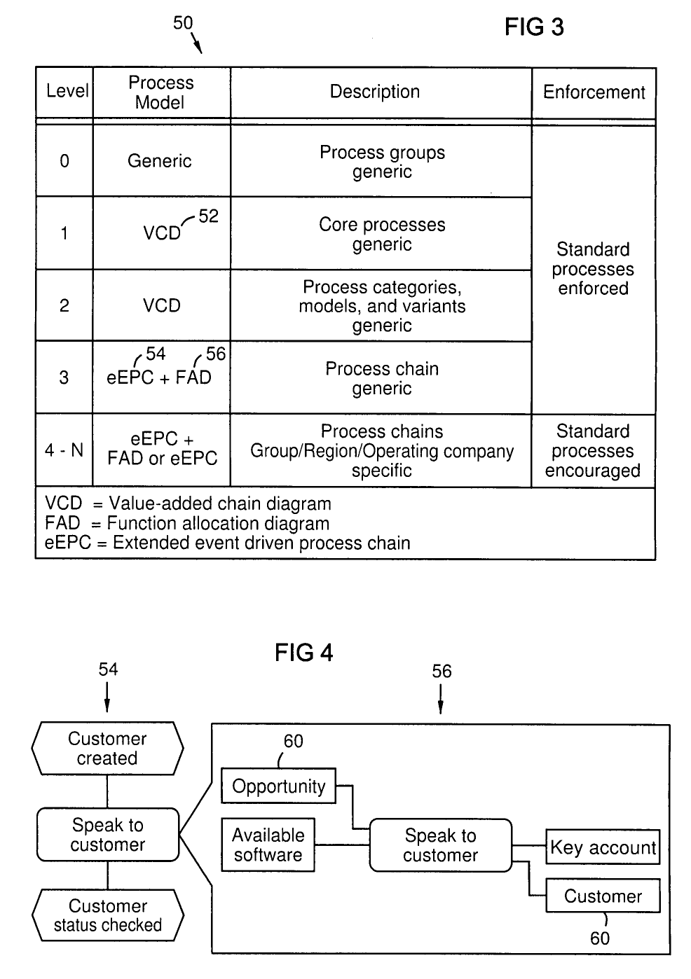

As shown in FIG. 3, the business view 30 may be described using process models including value added chain diagrams 52 (VCD), event-driven process chains 54 (EPC), and function allocation diagrams 56 (FAD). A value-added chain diagram 52 illustrates sequences of functions in a company that create the company's added value. It illustrates the subordination of functions, and displays function links to organizational units and information objects. A function allocation diagram 56 allocates the defined functions among available resources (human, hardware, software). An event-driven process chain 54 describes a flow of control of business processes as a chain of functions, events, and logical connectors (AND, OR, XOR, etc.). Functions represent activities in a business process. An event may trigger a function or signal termination of a function. EPCs extended with data, resources, time and probabilities, are called extended EPCs (eEPCs). A process may be considered as a quantity of functions triggered by one or more events. Event-driven process chains 54 are especially useful as the basis for a technical description of IT products, since they offer a detailed description of process elements and events in the form of a logical flow chart.

FIG. 3 illustrates modeling development levels 50 in a business view 30. FIG. 4 shows an example of an event-driven process chain 54 and a function allocation diagram 56. The function allocation diagram 56 describes the function “Speak to Customer” in more detail, and is given here as an example.

The business view 30 is the description of the business itself, the logical flow, and the entities the business uses to fulfill its goals. It is a broad overview of the whole enterprise, which is necessary to come to a common understanding. The process descriptions are stored in a central repository or database, and are accessible to all responsible entities. A business view 30 is a high level view and is the starting point for any change. Business models are updated and redefined to reflect the change. The right level of detail in the business view is crucial for a successful corresponding change in the IT support. In the current state of the art, semantic data models are seldom unavailable in the business view to create a common understanding among business entities and between the business view 30 and the implementation view 40. Semantic standards are needed to create a common language as the basis for the implementation view 40 and for reliable communication between applications and their internal data models.

The implementation view 40 describes the IT implementation and support of the business view 30. Logical models 42 and physical data models 44 are created. In the current state of the art a broader overview of multiple projects may be lacking, and a link to the business view may be missing in modeling of the implementation view. There are two main reasons for this: 1) People tend to think in compartmentalized organizational units, each solving a current problem rather than understanding the big picture, which would require that the IT people understand the business view; 2) The descriptions available for the business processes is often not sufficient, possibly because the business people are unable to formulate their need. Thus data models currently tend to be specific to each project, and of varying quality and standards. There is no unifying general review of the logical data models to align them to each other. Without a common understanding about the data and its standardization, the successful implementation of a service-oriented architecture is not possible.

Thus a holistic modeling approach is needed that links the different views. One aspect of this is a technical linkage of elements between the different modeling approaches. Another aspect is integration of the models of one view into the other views. With such integration the participants obtain a broader view beyond their compartments. Business people can use parts of IT models and the other way around. For technical integration, core model elements are provided for the different views and are linked to each other. Core elements called business object types 60 (BOT) represent basic entities such as a person, place, thing, or concept. Business object types 60 represent items of the real business world and their properties. A business object is an instance of a business object type. An example for a business object type is CUSTOMER with the properties:

CUSTOMER

Name
Order Volume
Delivery Address
Credit Rating
Customer Rating

An example of a business object for this business object type as represented in a table or template for a given customer is:

| | |
|---|---|
| Name | ABC |
| Order Volume | $5.0 M |
| Delivery Address | 101 1st Street, |
| | First City, First |
| | State, USA |
| Credit Rating | B+ |
| Customer Rating | A− |

In the current state of the art, the business view 30 normally does not describe the basic entities the business deals with, because the focus is on process flow and the elements used to realize the flow. To integrate the data modeling aspect, a modeling element is needed in the business view that reflects the data entities needed on the implementation level. According to aspects of the invention, business object types 60 are added to function allocation diagrams 56, which are linked to event-driven process chains 54 as shown in FIG. 4. This combination of modeling elements is used in the business view 30 of FIG. 3 from level 3 onward. The event-driven process chains 54 show the general business flow. For any process step or function, a detailed function allocation diagram 56 explains it in more detail. The business object types 60 capture the fundamental information needs of the process elements.

The function allocation diagram of FIG. 4 shows two business object types 60: Opportunity and Customer as examples. Any business object type is described using a unique name, a description, and synonyms if needed. Synonyms accommodate variations in terminology used by different departments without adding entities to the model. These definitions allow all departments to communicate without mistakes, and without duplication of information. Tracking this information and explaining that synonyms refer to the same information, and storing them only once is very important. An example definition for the business object type OPPORTUNITY is shown in FIG. 5.

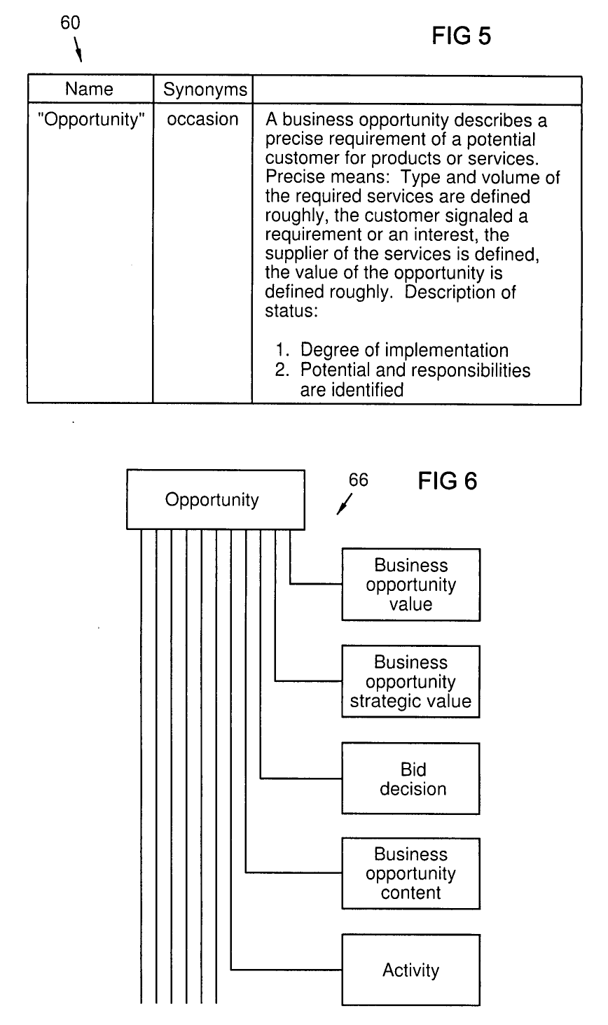

A more detailed description of business object types in the business view may be created with technical term models 66 to create semantic models of the information needs. FIG. 6 shows a technical term model 66 of the business object type OPPORTUNITY from FIG. 5. This provides semantic relationships among business object types used in the business view. Use of technical term models 66 provides a sound basis for logical data models in the IT-related implementation view.

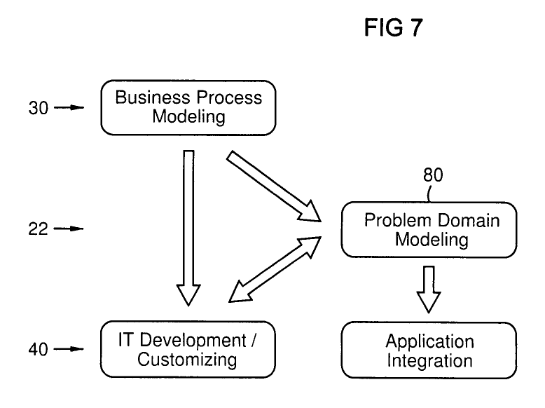

Direct links between the business object types 60 of the business view 30 and the project specific descriptions of the implementation view 40 are difficult, due to different requirements, granularity, and maintenance. For this reason, a logical problem domain model 80 may be provided as in FIG. 7 based on the business object types 60 and their semantic models 66 of the business view 30.

The implementation view 40 describes the concrete project level, where IT support for the business processes is developed or packaged software is selected and often customized. Any project of the implementation view must conform to the associated problem domain model 80. This is especially true for self-developed applications. Packaged software may be customized based on the business object types 60 and the related logical data models 52, 54, 56, 66. Data exchange between applications uses the business object types 60 as the application independent interchange language. FIG. 7 is an overview of the present modeling approach in context of the different views. The implementation view 40 may provide feedback to the problem domain model 80.

Data structures and databases may be used as known in the art of computer science for reducing the models herein to practice. A central repository or database may encode the data structures, storing representations of the models and the business object types, and maintaining relations among business object types used in the business view, the problem domain view, and the implementation view. The database is made available to all relevant departments in an enterprise, providing human-readable representations of the structured data to coordinate the departments in implementing a product life cycle of the enterprise

A data structure is a physical or logical relationship among data elements designed to support specific data manipulation functions (per The New IEEE Standard Dictionary of Electrical and Electronics Terms 308 (5th ed. 1993)). A computer-readable medium encoded with a data structure defines structural and functional interrelationships between the data structure and the computer software and hardware components, which permits the data structure's functionality to be realized. This is statutory subject matter for a patent under 35 USC 101 per the Manual of Patent Examining Procedure 2106.01(I).

The present holistic modeling approach provides major benefits for managing the data and information perspective of an enterprise by creating a transparent picture from the business needs to the implementation of these needs. Linking the IT data view and the business information needs based on business processes offers long-term benefits in managing changes. This is a point where prior approaches of enterprise-wide date modeling have failed. Incorporating the use of the present models into the daily work of people on both the business-side and the IT-side enables a stable, model-based, and transparent enterprise. This enables standardizing of data and a consistent language across the enterprise, providing a basis for reliable communication within a service-oriented architecture, and allowing this architecture to fulfill its promise.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A data structure embodied in a computer-readable medium, comprising:
a logical business model that defines processes and organization of an enterprise;
an implementation model that defines an information technology supporting the business model;
a plurality of business object types that define core elements of the business model and the implementation model;
a plurality of business objects, each comprising an instance of one of the business object types;
a data structure embodied in a computer database that stores a representation of the business model, the implementation model, and, for each of the business object types, a business object type definition and respective business objects or instantiations of the business object type, the database accessible to a plurality of departments in an enterprise;
the data structure and the database defining structural and functional interrelationships between the business model and the implementation model via logical and physical linkages among the business object types and the models; and
wherein human-readable representations of structured data from the database coordinate the departments in implementing a product life cycle in the enterprise.

2. The data structure of claim 1, further comprising in the business model:
a value-added chain level that models core processes in the business model, and an event-driven process chain level that models process chains in the business model.

3. The data structure of claim 2, further comprising:
a function allocation diagram linked to a function in an event-driven process chain in the event-driven process chain level to further describe the function.

4. The data structure of claim 1, wherein the business object type definition comprises a technical term model with links that indicate semantic relationships among the business object types.

5. The data structure of claim 4 wherein the definition of a given business object type comprises a primary object type name and a list of synonyms, and each synonym refers only to the given business object type without duplication of business object types for different terms of usage with the same meaning in the enterprise.

6. The data structure of claim 5, further comprising:
a logical problem domain model based on the business object types, their respective definitions, and their respective technical term models, wherein the implementation model defines and supports information technology projects conforming to the logical problem domain model.

7. A method of modeling and implementing an information technology product in a business, comprising:
creating a logical business model that defines processes and organization of an enterprise;
creating an implementation model that defines an information technology product supporting the business model;
creating a plurality of business object types that define core elements of the business model and the implementation model;
creating a computer database that stores a representation of the business model, the implementation model, and, for each of the business object types, a business object type definition and respective business objects or instantiations of the business object type, the database being accessible to a plurality of departments in an enterprise, the database defining structural and functional interrelationships between the business model and the implementation model via logical and physical linkages among the business object types; and
presenting human-readable representations of structured data from the database that coordinate the departments in implementing the information technology.

8. The method of claim 7, further comprising:
establishing multiple levels of model development comprising a value added chain modeling level that models core processes in the logical business model, and an event-driven process chain level that models process chains in the logical business model.

9. The method of claim 8, further comprising:
linking a function allocation diagram to a respective function in an event-driven process chain to further describe the function.

10. The method of claim 9, wherein the business object type definition comprises a technical term model with links that indicate semantic relationships among the business object types.

11. The method of claim 10 wherein the definition of a given business object type comprises a primary object type name and a list of synonyms, and each synonym refers only to the given business object type without duplication of business object types for different terms of usage with the same meaning in the enterprise.

12. The method of claim 11, further comprising:
creating a logical problem domain model based on the business object types, their respective definitions, and their respective technical term models, and wherein the implementation model defines and supports information technology projects conforming to the logical problem domain model.

13. The method of claim 12, further comprising developing information technologies based on the implementation model to support the processes and organization of the enterprise.
